(19) United States
(12) Patent Application Publication
(10) Pub. No.: US 2026/0317960 A1
(43) Pub. Date: Oct. 15, 2026

(54) REMOVAL OF POLYURETHANE FIBERS FROM TEXTILES

(71) Applicant: Katholieke Universiteit Leuven, Leuven (BE)

(72) Inventors: Dirk De Vos, Leuven (BE); Niels Van Velthoven, Leuven (BE)

(73) Assignee: Katholieke Universiteit Leuven, Leuven (BE)

(21) Appl. No.: 19/473,945

(22) PCT Filed: Apr. 12, 2024
(86) PCT No.: PCT/EP2024/059995

§ 371 Date: Oct. 9, 2025

(30) Foreign Application Priority Data
Apr. 13, 2023 (EP) 23167753.5

(51) Int. Cl. D01G 11/00; C08J 11/28

(52) U.S. Cl. CPC D01G 11/00; C08J 11/28; C08J 2301/02; C08J 2367/02; C08J 2377/00; C08J 2475/04; D10B 2331/04

(57) ABSTRACT

The present invention relates to a method to remove polyurethane fibers from a textile product comprising polyurethane fibers and non-polyurethane fibers using a splitting solution comprising a secondary amine, wherein said secondary amine does not contain any primary amine group and wherein each of the two carbon atoms attached to the nitrogen atom in the secondary amine group comprised within said secondary amine form bonds with at least two hydrogen atoms.

### FIELD OF THE INVENTION

The present invention relates to a method to remove polyurethane fibers from a textile product comprising polyurethane fibers and non-polyurethane fibers.

### BACKGROUND OF THE INVENTION

An enormous amount of textile waste is generated each year, most of which is disposed of via incineration or landfilling. To decrease the textile industry's environmental impact, the recycling of textile products has received increased attention in recent years. The most common recycling method is mechanical recycling, in which the textile product is shredded, and the resulting fibers are recovered and spun into yarn to create new textile products. However, waste textile products often contain too many impurities to be converted into high-quality yarn via mechanical recycling. Chemical recycling can offer a solution for such textile waste streams since, in chemical recycling, the textile fibers are broken down into their molecular building blocks, which can be recovered and reused to make new high-quality fibers and, eventually, new textile products.

Textile products often consist of a mixture of different types of textile fibers to provide optimal product properties, such as strength, durability, resilience, and elasticity. Given their superior stretch and elastic recovery ability, polyurethane (PU) fibers, such as elastane and the like, are often mixed with other synthetic, semi-synthetic or natural fibers, such as nylon, polyester, cotton, rayon, and the like, to ensure excellent fitting and comfort characteristics of the final textile products. However, the presence of even small quantities of polyurethane fibers often impedes the mechanical or chemical recycling processes of the non-polyurethane fibers. The selective removal of polyurethane fibers from textile products is thus highly desired.

Some methods to selectively remove polyurethane fibers have been proposed in recent years. The most common way to remove polyurethane fibers from mixed-fiber textile products is to selectively dissolve the polyurethane fibers in amide-based solvents, such as N,N-dimethylformamide (DMF) and N,N-dimethylacetamide (DMAc). Such dissolution methods have several disadvantages that impede their industrial implementation, such as the required large excess of harmful amide-based solvents like DMF and DMAc, the high energy input needed to recycle the high-boiling amide-based solvents, and the long dissolution times that are generally needed to dissolve the polyurethane fibers. Moreover, also some non-polyurethane fibers, such as cotton and wool, are known to be prone to (partial) dissolution in amide-based solvents. Alternatively, polyurethane fibers can be thermally decomposed via a high temperature treatment followed by a washing step to remove the decomposed polyurethane compounds. High temperatures of 190-220° C. are preferred to decompose the polyurethane fibers efficiently. However, such thermal decomposition methods can only be applied to textile products comprising thermally stable fibers as the non-polyurethane fibers, such as polyamides, and even then, the (partial) degradation of the non-polyurethane fibers cannot be entirely avoided. Besides dissolution and thermal decomposition methods, polyurethane fibers can also be selectively removed from mixed-fiber textile products via chemolysis, in which the polyurethane polymers are cleaved into their molecular building blocks by chemical splitting agents, such as water (i.e. hydrolysis), alcohols (i.e. alcoholysis) or amines (i.e. aminolysis). For instance, monofunctional aliphatic alcohols have been used to selectively remove polyurethane-based adhesives from textile fabrics comprising polytetrafluoroethylene material. Additionally, water in combination with strong acids (e.g. H₂SO₄), has been used as a splitting agent to (partially) remove polyurethane fibers from textile fabrics comprising cotton fibers as the non-polyurethane fibers. However, these methods are only suitable for textile products comprising non-polyurethane fibers that display high chemical resistance. Indeed, hydrolysis and alcoholysis are also common chemolysis methods to cleave non-polyurethane fibers, such as polyester fibers, and are thus not suitable to selectively remove polyurethane fibers from a broad range of mixed-fiber textile products. WO2020/130825 describes a method to remove polyurethane fibers from textile products comprising polyurethane fibers and cellulose fibers via a combination of amide-based solvent dissolution and aminolysis, a combination of amide-based solvent dissolution and glycolysis, a combination of aminolysis and glycolysis, or a combination of all three methods. In this process, the mixed-fiber fabric is subjected to a mixture of an amide-based solvent (e.g. DMF) and an amine, or an amide-based solvent and a glycol, or an amine and a glycol, or an amide-based solvent, an amine, and a glycol. Evidently, the previously discussed disadvantages of the amide-based solvent dissolution methods and glycolysis methods are also valid when these methods are used in combination with aminolysis.

It is clear from the prior art that there is a compelling need for simple, industrially relevant methods that selectively and efficiently remove polyurethane fibers from mixed-fiber textile products without removing or destroying a wide range of other types of textile fibers and using chemicals that easily can be recovered.

Here the inventors have developed a method for the selective removal of polyurethane fibers from a wide range of mixed-fiber textile products based on the use of small secondary amines with low steric hindrance around the nitrogen atom, such as diethylamine, piperidine, morpholine, dimethylamine and pyrrolidine, as splitting agents. The use of small secondary amines with low steric hindrance around the nitrogen atom unexpectedly increase the efficacy of aminolysis of PU fibers and allow the selective removal of polyurethane fibers without requiring amide-based solvents.

### SUMMARY

The present invention relates to a method to remove polyurethane fibers from a textile product comprising polyurethane (PU) fibers and non-polyurethane fibers, comprising the steps of:
a. immersing said textile product in a splitting solution comprising a secondary amine, wherein said secondary amine does not contain any primary amine group and wherein each of the two carbon atoms attached to the nitrogen atom in the secondary amine group comprised within said secondary amine form bonds with at least two hydrogen atoms; and,
b. heating said splitting solution comprising said textile product to split the polyurethane fibers, thereby removing polyurethane fibers from said textile product.

In one embodiment, said secondary amine is of formula (I)

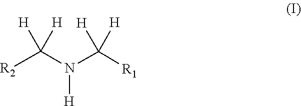

wherein each of R₁ and R₂, is independently selected from H or from the group consisting of alkyl, alkenyl, alkoxy, alkyloxyalkyl, alkyloxyalkyloxy, cycloalkyl, cycloalkoxy, aryl, aryloxy and arylalkyl or wherein R₁ and R₂ form an heterocycle.

In one embodiment, said secondary amine is selected from the group consisting of diethylamine, piperidine, morpholine, dimethylamine, pyrrolidine, diallylamine, dipropylamine, dibutylamine, and mixtures thereof.

In one embodiment, said secondary amine is selected from the group consisting of diethylamine, piperidine, morpholine, dimethylamine, pyrrolidine, diallylamine, and mixtures thereof, more preferably selected from the group consisting of diethylamine, piperidine, morpholine, dimethylamine, and mixtures thereof.

In one embodiment, said secondary amine is selected from the group consisting of diethylamine, piperidine, morpholine, and mixtures thereof.

In one embodiment, said secondary amine is diethylamine.

In one embodiment, the weight of secondary amine in the splitting solution is at least 80% of the weight of polyurethane fibers in said textile product, preferably at least 200%, 500% or 1000% of the weight of polyurethane fibers in said textile product, more preferably at least 1500% of the weight of polyurethane fibers in said textile product.

In one embodiment, the splitting solution further comprises a catalyst selected from the group consisting of alkali hydroxides, tertiary amines, non-nucleophilic bases, Lewis acids and mixtures thereof.

In one embodiment, the splitting solution further comprises an oxidant or a reductant.

In one embodiment, the splitting solution further comprises a solvent selected from the group consisting of tetrahydrofuran, acetonitrile, acetone, and mixtures thereof.

In one embodiment, the splitting solution further comprises a solvent selected from the group consisting of, tetrahydrofuran, acetonitrile, acetone, and mixtures thereof.

In one embodiment, the splitting solution further comprises a solvent, preferably a solvent selected from the group comprising water, an organic solvent, and combinations thereof, more preferably a solvent selected from the group consisting of tetrahydrofuran, acetonitrile, acetone, and mixtures thereof.

In one embodiment, step b is performed at a temperature ranging from 40° C. to 250° C., preferably ranging from 50° C. to 200° C., more preferably ranging from 70° C. to 150° C., more preferably ranging from 80° C. to 130° C.

In one embodiment, the duration of step b is at least 20 min, preferably at least 60 min, more preferably at least 120 min.

In one embodiment, the duration of step b is at least 1 min, 5 min or 15 min, preferably at least 20 min, more preferably at least 60 min, even more preferably at least 120 min.

In one embodiment, said non-polyurethane fibers comprise polyester fibers.

In one embodiment, the method of the invention further comprises, after the heating step b, the step of:
c. separating the textile product from the splitting solution and, optionally, separating said secondary amine and/or solvent from the splitting solution.

In one embodiment, the methods of the invention comprises, after the separating step c, the step of:
d. washing the textile product.

### Definitions

In the present invention, the following terms have the following meaning.

As used herein, the singular forms “a”, “an”, and “the” include both singular and plural referents unless the context clearly dictates otherwise. By way of example, “a compound” means one compound or more than one compound.

Whenever the term “substituted” is used herein, it is meant to indicate that one or more hydrogen atoms on the atom indicated in the expression using “substituted” is replaced with a selection from the indicated group, provided that the indicated atom's normal valence is not exceeded, and that the substitution results in a chemically stable compound, i.e., a compound that is sufficiently robust to survive isolation from a reaction mixture.

The term “hydrocarbyl” group is used herein in accordance with the definition specified by IUPAC as follows: a univalent group formed by removing a hydrogen atom from a hydrocarbon (that is, a group containing only carbon and hydrogen).

The term “alkyl” as a group or part of a group, refers to a hydrocarbyl group of formula CₙH₂ₙ₊₁ wherein n is a number greater than or equal to 1, with no site of unsaturation. Alkyl groups may be linear or branched and may be substituted as indicated herein. Generally, alkyl groups of this invention comprise from 1 to 18 carbon atoms, preferably from 1 to 10 carbon atoms, more preferably from 1 to 6 carbon atoms, more preferably from 1 to 4 carbon atoms, even more preferably 1 to 2 carbon atoms. When a subscript is used herein following a carbon atom, the subscript refers to the number of carbon atoms that the named group may contain. For example, the term “C₁₋₆alkyl”, as a group or part of a group, refers to a hydrocarbyl group of formula CₙH₂ₙ₊₁ wherein n is a number ranging from 1 to 6. Thus, for example, “C₁₋₆alkyl” includes all linear or branched alkyl groups with between 1 and 6 carbon atoms, and thus includes methyl, ethyl, n-propyl, i-propyl, butyl, and its isomers (e.g., n-butyl, i-butyl, and t-butyl); pentyl and its isomers, hexyl, and its isomers, etc. For example, C₁₋₄alkyl includes all linear or branched alkyl groups having 1 to 4 carbon atoms, and thus includes for example methyl, ethyl, n-propyl, i-propyl, 2-methyl-ethyl, butyl, and its isomers (e.g., n-butyl, i-butyl, and t-butyl), and the like. In particular embodiments, the term alkyl refers to C₁₋₁₂alkyl (C₁₋₁₂ hydrocarbons), yet more in particular to C₁₋₉alkyl (C₁₋₉ hydrocarbons), yet more in particular to C₁₋₆alkyl (C₁₋₆ hydrocarbons) as further defined herein above. Non-limiting examples of alkyl include methyl, ethyl, 1-propyl (n-propyl), 2-propyl (iPr), 1-butyl, 2-methyl-1-propyl (i-Bu), 2-butyl (s-Bu), 2-dimethyl-2-propyl (t-Bu), 1-pentyl (n-pentyl), 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, and n-icosyl.

When the suffix “ene” is used in conjunction with an alkyl group, i.e., “alkylene”, this is intended to mean the alkyl group as defined herein having two single bonds as points of attachment to other groups. As used herein, the term “alkylene” also referred as “alkanediyl”, by itself or as part of another substituent, refers to alkyl groups that are divalent, i.e., having two monovalent group centers derived by the removal of two hydrogen atoms from the same or two different carbon atoms of a parent alkane, i.e., with two single bonds for attachment to two other groups. Alkylene groups may be linear or branched and may be substituted as indicated herein. Non-limiting examples of alkylene groups include methylene (—CH₂—), ethylene (—CH₂—CH₂—), methylmethylene (—CH(CH₃)—), 1-methyl-ethylene (—CH(CH₃)—CH₂—), n-propylene (—CH₂—CH₂—CH₂—), 2-methylpropylene (—CH₂—CH(CH₃)—CH₂—), 3-methylpropylene (—CH₂—CH₂—CH(CH₃)—), n-butylene (—CH₂—CH₂—CH₂—CH₂—), 2-methylbutylene (—CH₂—CH(CH₃)—CH₂—CH₂—), 4-methylbutylene (—CH₂—CH₂—CH₂—CH(CH₃)—), pentylene and its chain isomers, hexylene and its chain isomers.

The term “cycloalkyl”, as a group or part of a group, refers to a cyclic alkyl group, that is a monovalent, saturated, hydrocarbyl group having 1 or more cyclic structure, and comprising from 3 to 20 carbon atoms, more preferably from 3 to 10 carbon atoms, more preferably from 3 to 8 carbon atoms; more preferably from 3 to 6 carbon atoms. Cycloalkyl includes all saturated hydrocarbon groups containing 1 or more rings, including monocyclic, bicyclic groups or tricyclic. For example, cycloalkyl comprises a C₃₋₁₀ monocyclic or C₇₋₁₈ polycyclic saturated hydrocarbon, such as for instance cyclopropyl, cyclobutyl, cyclopentyl, cyclopropylethylene, methylcyclopropylene, cyclohexyl, cycloheptyl, cyclooctyl, cyclooctylmethylene, norbornyl, fenchyl, trimethyltricycloheptyl, decalinyl, adamantyl and the like. The further rings of multi-ring cycloalkyls may be either fused, bridged and/or joined through one or more spiro atoms. When a subscript is used herein following a carbon atom, the subscript refers to the number of carbon atoms that the named group may contain. For example, the term “C₃₋₁₀cycloalkyl”, refers to a cyclic alkyl group comprising from 3 to 10 carbon atoms. For example, the term “C₃₋₈cycloalkyl”, refers to a cyclic alkyl group comprising from 3 to 8 carbon atoms. For example, the term “C₃₋₆cycloalkyl”, refers to a cyclic alkyl group comprising from 3 to 6 carbon atoms. For the avoidance of doubt, fused systems of a cycloalkyl ring with a heterocyclic ring are considered as heterocycle irrespective of the ring that is bound to the core structure. Fused systems of a cycloalkyl ring with an aryl ring are considered as aryl irrespective of the ring that is bound to the core structure. Fused systems of a cycloalkyl ring with a heteroaryl ring are considered as heteroaryl irrespective of the ring that is bound to the core structure.

The term “alkoxy” or “alkyloxy”, as a group or part of a group, refers to a group of formula —OR^{b} wherein R^{b} is alkyl as defined herein. Non-limiting examples of suitable C₁₋₆alkoxy include methoxy, ethoxy, propoxy, isopropoxy, butoxy, isobutoxy, sec-butoxy, tert-butoxy, pentyloxy, and hexyloxy.

The term “alkoxyalkyl” or “alkyloxyalkyl”, as a group or part of a group, refers to a group of formula —R^{a}—OR^{b} wherein R^{a} is alkylene and R^{b} is alkyl as defined herein.

The term “alkoxyalkoxy” or “alkyloxyalkyloxy”, as a group or part of a group, refers to a group of formula —O—R^{a}—OR^{b} wherein R^{a} is alkylene and R^{b} is alkyl as defined herein.

The term “cycloalkoxy”, as a group or part of a group, refers to a group of formula —OR^{g} wherein R^{g} is cycloalkyl as defined herein.

The term “aryl”, as a group or part of a group, refers to a polyunsaturated, aromatic hydrocarbyl group having a single ring (i.e., phenyl) or multiple aromatic rings fused together (e.g., naphthyl), or linked covalently, typically containing 6 to 20 atoms; preferably 6 to 10, wherein at least one ring is aromatic. Typical aryl groups include, but are not limited to 1 ring, or 2 or 3 rings fused together, derived from benzene, naphthalene, anthracene, biphenyl, and the like. The aromatic ring may optionally include one to two additional rings. Fused systems of an aryl ring with a cycloalkyl ring, or a cycloalkenyl ring, or a cycloalkynyl ring, are considered as aryl irrespective of the ring that is bound to the core structure. Fused systems of an aryl ring with a heterocycle are considered as heterocycle irrespective of the ring that is bound to the core structure. Fused systems of an aryl ring with a heteroaryl are considered as heteroaryl irrespective of the ring that is bound to the core structure. Examples of suitable aryl include C₆₋₂₀aryl, preferably C₆-10aryl, more preferably C₆₋₉aryl. Non-limiting examples of aryl comprise phenyl, biphenylyl, biphenylenyl, or 1- or 2-naphthanelyl; 1-, 2-, 3-, 4-, 5- or 6-tetralinyl (also known as “1,2,3,4-tetrahydronaphtalene); 1-, 2-, 3-, 4-, 5-, 6-, 7- or 8-azulenyl, 4-, 5-, 6 or 7-indenyl; 4- or 5-indanyl; 5-, 6-, 7- or 8-tetrahydronaphthyl; 1,2,3,4-tetrahydronaphthyl; and 1,4-dihydronaphthyl; 1-, 2-, 3-, 4- or 5-pyrenyl.

The term “arylalkyl”, as a group or part of a group, refers to an alkyl as defined herein, wherein at least one hydrogen atom is replaced by at least one aryl as defined herein. Non-limiting examples of arylalkyl group include benzyl, phenethyl, dibenzylmethyl, benzyl, 2-phenylethan-1-yl, 2-phenylethen-1-yl, naphthylmethyl, 2-naphthylethyl, and the like. The term “C₆₋₁₀arylC₁₋₆alkyl” means that the alkyl moiety of the arylalkyl group can comprises 1 to 6 carbon atoms and the aryl moiety is 6 to 10 carbon atoms.

The term “aryloxy”, as a group or part of a group, refers to a group of formula —O—R^{f} wherein R^{f} is aryl as defined herein.

The term “arylalkoxy” or “arylalkyloxy”, as a group or part of a group, refers to a group of formula —O—R^{a}—R^{f} wherein R^{f} is aryl, and R^{a} is alkylene as defined herein.

The term “heterocycle” or “heterocyclyl” as used herein refer to non-aromatic, fully saturated or partially unsaturated ring system comprising from 3 to 18 atoms including at least one N, O, S, or P, preferably 3 to 14 atoms (3-14 membered heterocyclyl) (for example, 3 to 7 member monocyclic, 7 to 14 member bicyclic, preferably comprising a total of 3 to 10 ring atoms (3-10 membered heterocyclyl), more preferably 4 to 10 atoms (4-10 membered heterocyclyl), yet more preferably 5 to 10 atoms (5-10 membered heterocyclyl). Each ring of the heterocycle or heterocyclyl may have 1, 2, 3 or 4 heteroatoms selected from N, O, P and/or S, where the N and S heteroatoms may optionally be oxidized, and the N heteroatoms may optionally be quaternized; and wherein at least one carbon atom of heterocyclyl can be oxidized to form at least one C═O. The heterocyclyl may be attached at any heteroatom or carbon atom of the ring or ring system, where valence allows. The rings of multi-ring heterocyclyls or heterocycles may be fused, bridged and/or joined through one or more spiro atoms. Fused systems of a heterocycle or heterocyclyl with an aryl ring are considered as heterocycle or heterocyclyl irrespective of the ring that is bound to the core structure. Fused systems of a heterocycle or heterocyclyl with a heteroaryl ring are considered as heteroaryl irrespective of the ring that is bound to the core structure.

The term “alkenyl” as a group or part of a group, refers to an unsaturated hydrocarbyl group, which may be linear, or branched, comprising one or more carbon-carbon double bonds. When a subscript is used herein following a carbon atom, the subscript refers to the number of carbon atoms that the named group may contain. For example, the term “alkenyl” refers to an unsaturated hydrocarbyl group, which may be linear, or branched comprising one or more carbon-carbon double bonds and comprising from 2 to 6 carbon atoms. For example, C₂₋₄alkenyl includes all linear, or branched alkenyl groups having 2 to 4 carbon atoms. Examples of C₂₋₆alkenyl groups are ethenyl, 2-propenyl, 2-butenyl, 3-butenyl, 2-pentenyl and its isomers, 2-hexenyl and its isomers, 2,4-pentadienyl, and the like. Generally, alkenyl groups of this invention comprise from 2 to 18 carbon atoms, preferably from 2 to 10 carbon atoms, more preferably from 2 to 6 carbon atoms, more preferably from 2 to 4 carbon atoms, even more preferably 2 carbon atoms.

The term “fiber” is used herein in reference to the strands or filaments that can make up threads or yarns used to make textile products.

“Polyurethane fibers” is used herein in reference to synthetic fibers made with polyurethane polymers. Examples of polyurethane fibers include, without being limited to, elastane, spandex, Lycra® and Elaspan®. The person skilled in the art knows that polyurethane polymers are commonly made by reacting at least one polyisocyanate compound with at least one polyol compound, with optionally the addition of additives commonly used in the synthesis of polyurethane materials, such as chain-extenders, crosslinking agents, catalysts, surfactants, stabilizers, flame retardants, organic and inorganic fillers, pigments, and anti-oxidants. The polyisocyanate compounds used for the synthesis of the polyurethane polymers can be selected from aliphatic, cycloaliphatic, araliphatic, or aromatic polyisocyanates. Preferably, the polyisocyanate compounds are selected from toluene diisocyanates (TDI), methylene diphenyl isocyanates (MDI), or higher homologs like polymeric MDI (pMDI), having isocyanate functionalities of at least 2.

“Non-polyurethane fibers” is used herein in reference to fibers made without polyurethane polymers. Examples of non-polyurethane fibers include, without being limited to, natural fibers, such as cotton, wool, silk and linen, or synthetic fibers, such as polyester fibers, polyamide fibers and polyacrylonitrile fibers, and semi-synthetic fibers, such as rayon, lyocell and Modal® fibers.

“Polyester fibers” is used herein in reference to synthetic fibers made with polyester polymers. The person skilled in the art knows that polyester polymers are commonly made by reacting at least one dicarboxylic acid compound, such as terephthalic acid, with at least one diol compound, such as ethylene glycol, with optionally the addition of additives and catalysts. Common types of polyester polymers used in the synthesis of polyester-based fibers are polyethylene terephthalate (PET), polybutylene terephthalate (PBT), polycyclohexylenedimethylene terephthalate (PCT), polytrimethylene terephthalate (PTT), and/or polyethylene naphthalate (PEN).

“Polyamide fibers” is used herein in reference to synthetic fibers made with polyamide polymers. Examples of polyamide fibers include, without being limited to, Nylon 6, Nylon 6,6, Nylon 4,6, Nylon 12, Antron®, Tactel®, Kevlar®, and Nomex®.

“Cellulose fibers” is used herein in reference to natural or semi-synthetic fibers that are derived from cellulose. Examples of cellulose fibers include, without being limited to, cotton, rayon, viscose, hemp, lyocell, and Modal®.

The term “textile product(s)” is used herein in reference to any material or combination of materials usually found in textiles. The term includes, without being limited to, cloths, fabrics, yarns, threads, filaments and fibers. In one embodiment, the textile product(s) is selected from the group consisting of cloths, fabrics, yarns, threads, filaments, fibers and mixtures thereof.

### DETAILED DESCRIPTION

The present invention relates to a method to remove polyurethane fibers from a textile product comprising polyurethane fibers and non-polyurethane fibers.

In one embodiment, the method of the invention is to selectively remove polyurethane fibers from a textile product comprising polyurethane fibers and non-polyurethane fibers. “selectively” is used herein in reference to the removal of polyurethane fibers without or with limited degradation or removal of non-polyurethane fibers.

In one embodiment, the wt % of non-polyurethane fibers degraded or removed in the method of the invention is inferior to 50 wt % of the total amount of non-polyurethane fibers in the textile product before removal of polyurethane-fibers using the method of the invention, preferably inferior to 45 wt %, 40 wt %, 35 wt %, 30 wt %, 29 wt %, 28 wt %, 27 wt %, 26 wt %, 25 wt %, 24 wt %, 23 wt %, 22 wt %, 21 wt %, 20 wt %, 19 wt %, 18 wt %, 17 wt %, 16 wt %, 15 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt % or 1 wt % of the total amount of non-polyurethane fibers in the textile product before removal of polyurethane-fibers using the method of the invention.

In one embodiment, the mol % of non-polyurethane fibers degraded or removed in the method of the invention is inferior to 50 mol % of the total amount of non-polyurethane fibers in the textile product before removal of polyurethane-fibers using the method of the invention, preferably inferior to 45 mol %, 40 mol %, 35 mol %, 30 mol %, 29 mol %, 28 mol %, 27 mol %, 26 mol %, 25 mol %, 24 mol %, 23 mol %, 22 mol %, 21 mol %, 20 mol %, 19 mol %, 18 mol %, 17 mol %, 16 mol %, 15 mol %, 14 mol %, 13 mol %, 12 mol %, 11 mol %, 10 mol %, 9 mol %, 8 mol %, 7 mol %, 6 mol %, 5 mol %, 4 mol %, 3 mol %, 2 mol % or 1 mol % of the total amount of non-polyurethane fibers in the textile product before removal of polyurethane-fibers using the method of the invention.

In one embodiment, the non-polyurethane fibers comprise polyester fibers. In other words, the textile product comprises, before removal of polyurethane-fibers using the method of the invention, polyurethane fibers and polyester fibers.

In one embodiment, the textile product comprising polyurethane fibers and non-polyurethane fibers, comprises, before removal of polyurethane-fibers using the method of the invention, 0.1 wt % to 30 wt % of polyurethane fibers, preferably 1 wt % to 25 wt % polyurethane fibers, more preferably 4 wt % to 15 wt % polyurethane fibers. In one embodiment, the textile product comprising polyurethane fibers and non-polyurethane fibers, comprises, before removal of polyurethane-fibers using the method of the invention, 2 wt % to 15 wt % polyurethane fibers.

The method of the invention comprises a step of immersing the textile product comprising polyurethane fibers and non-polyurethane fibers in a splitting solution. In other words, the method of the invention comprises a step of contacting the textile product comprising polyurethane fibers and non-polyurethane fibers with a splitting solution.

The textile product immersed in the splitting solution can be added in the form in which it is received, but preferably, it is reduced in size and/or increased in density in a suitable way known to the person skilled in the art, such as shredding, cutting, grinding, milling, pelletizing, pressing, densification and any combinations thereof. Optionally, the textile product is washed before being immersed in the splitting solution.

In one embodiment, the splitting solution comprises a secondary amine. Unless specified otherwise, the term “secondary amine” is used herein in reference to compounds comprising a secondary amine group.

In one embodiment, the secondary amine is not diethylenetriamine (CAS #111-40-0).

In one embodiment, the secondary amine does not contain any primary amine group. Compounds comprising primary amine group have been found by the inventors to decompose non-polyurethane fibers, such a polyester fibers, and have often a high boiling point making them difficult to recover via conventional separation methods such as distillation.

In one embodiment, each of the two carbon atoms bound to the nitrogen atom in the secondary amine group present within the secondary amine form bonds with at least two hydrogen atoms. Low steric hindrance around the nitrogen atom in the secondary amine group comprised within the secondary amine has been found by the inventors to increase efficiency of polyurethane removal in textile products.

In a preferred embodiment, the splitting solution comprises a secondary amine wherein the secondary amine does not contain any primary amine group and wherein each of the two carbon atoms bound to the nitrogen atom in the secondary amine group comprised within the secondary amine form bonds with at least two hydrogen atoms.

In one embodiment, said secondary amine is of formula (I)

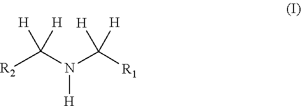

wherein each of R₁ and R₂, is independently selected from H or from the group consisting of alkyl, alkenyl, alkoxy, alkyloxyalkyl, alkyloxyalkyloxy, cycloalkyl, cycloalkoxy, aryl, aryloxy and arylalkyl or wherein R₁ and R₂ form a ring.

In one embodiment, each of R₁ and R₂, is independently selected from H or from the group consisting of alkyl, alkenyl, alkoxy, alkyloxyalkyl, alkyloxyalkyloxy, cycloalkyl, cycloalkoxy, aryl, aryloxy and arylalkyl or R₁ and R₂ form an heterocycle.

It is to be understood in the context of the invention that the ring or heterocycle formed by R₁ and R₂ includes the nitrogen and carbon atoms represented in formula (I).

In one embodiment, the secondary amine has a boiling point at standard atmospheric pressure of inferior or equal to 150° C., preferably inferior or equal to 130° C., more preferably inferior or equal to 100° C.

In one embodiment, the secondary amine is selected from the group consisting of diethylamine, piperidine, morpholine, dimethylamine, pyrrolidine, diallylamine, dipropylamine, dibutylamine, and mixtures thereof.

In one embodiment, the secondary amine is selected from the group consisting of diethylamine, piperidine, morpholine, dimethylamine, pyrrolidine, diallylamine and mixtures thereof.

In one embodiment, the secondary amine is selected from the group consisting of diethylamine, piperidine, morpholine, dimethylamine, and mixtures thereof.

In one embodiment, the secondary amine is selected from the group consisting of diethylamine, piperidine, morpholine, and mixtures thereof.

In one embodiment, the amount of compound comprising a primary amine group withing the splitting solution is inferior or equal to 25 wt %, preferably inferior or equal to 24 wt %, 23 wt %, 22 wt %, 21 wt %, 20 wt %, 19 wt %, 18 wt %, 19 wt %, 18 wt %, 19 wt %, 18 wt %, 17 wt %, 16 wt %, 15 wt %, 16 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt % or 1 wt %, more preferably inferior or equal to 0.9 wt %, 0.8 wt %, 0.7 wt %, 0.6 wt %, 0.5 wt %, 0.4 wt %, 0.3 wt %, 0.2 wt % or 0.1 wt %. In one embodiment, the splitting solution does not contain more than traces of compound comprising a primary amine group. In one embodiment, the splitting solution does not contain compound comprising a primary amine group.

In one embodiment, the amount of amide-based solvents within the splitting solution is inferior or equal to 25 wt %, preferably inferior or equal to 24 wt %, 23 wt %, 22 wt %, 21 wt %, 20 wt %, 19 wt %, 18 wt %, 19 wt %, 18 wt %, 19 wt %, 18 wt %, 17 wt %, 16 wt %, 15 wt %, 16 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt % or 1 wt %, more preferably inferior or equal to 0.9 wt %, 0.8 wt %, 0.7 wt %, 0.6 wt %, 0.5 wt %, 0.4 wt %, 0.3 wt %, 0.2 wt % or 0.1 wt %. In one embodiment, the splitting solution does not contain more than traces of amide-based solvents. In one embodiment, the splitting solution does not contain amide-based solvents. Amide-based solvents refers to compounds comprising an amide group.

In one embodiment, the amount of glycol within the splitting solution is inferior or equal to 25 wt %, preferably inferior or equal to 24 wt %, 23 wt %, 22 wt %, 21 wt %, 20 wt %, 19 wt %, 18 wt %, 19 wt %, 18 wt %, 19 wt %, 18 wt %, 17 wt %, 16 wt %, 15 wt %, 16 wt %, 14 wt %, 13 wt %, 12 wt %, 11 wt %, 10 wt %, 9 wt %, 8 wt %, 7 wt %, 6 wt %, 5 wt %, 4 wt %, 3 wt %, 2 wt % or 1 wt %, more preferably inferior or equal to 0.9 wt %, 0.8 wt %, 0.7 wt %, 0.6 wt %, 0.5 wt %, 0.4 wt %, 0.3 wt %, 0.2 wt % or 0.1 wt %. In one embodiment, the splitting solution does not contain more than traces of glycol. In one embodiment, the splitting solution does not contain glycol.

In one embodiment, the amount of secondary amine in the splitting solution is sufficient to split polyurethane fibers in the textile product.

In one embodiment, the splitting solution comprises at least 0.05 kg, 0.1 kg, 1 kg, or 5 kg of secondary amine per kg of polyurethane fibers in said textile product.

In one embodiment, the splitting solutions comprises secondary amine in an amount ranging from 0.05 kg to 1000 kg of secondary amine per kg of polyurethane fibers in said textile product, more preferably ranging from 0.1 kg to 500 kg of secondary amine per kg of polyurethane fibers in said textile product, even more preferably ranging from 1 kg to 300 kg of secondary amine per kg of polyurethane fibers in said textile product, yet more preferably ranging from 5 kg to 100 kg of secondary amine per kg of polyurethane fibers in said textile product.

In one embodiment, the weight of secondary amine in the splitting solution is ranging from 80% to 90000% of the weight of polyurethane fibers in the textile product before removal of PU fibers using the method of the invention, preferably from 200% to 45000%, from 500% to 30000% or from 1000% to 20000% of the weight of polyurethane fibers in the textile product before removal of PU fibers using the method of the invention, more preferably from 1500% to 15000% of the weight of polyurethane fibers in the textile product before removal of PU fibers using the method of the invention.

In one embodiment, the weight of secondary amine in the splitting solution is at least 80% of the weight of polyurethane fibers in the textile product before removal of PU fibers using the method of the invention, preferably at least 200%, 500% or 1000% of the weight of polyurethane fibers in the textile product before removal of PU fibers using the method of the invention, more preferably at least 1500% or 3000% of the weight of polyurethane fibers in the textile product before removal of PU fibers using the method of the invention.

A catalyst, such as alkali hydroxides (e.g. sodium hydroxide, potassium hydroxide), alkali alkoxides (e.g. sodium methoxide, potassium methoxide, sodium tert-butoxide, potassium tert-butoxide), tertiary amines (e.g. triethylamine, 1,4-diazabicyclo[2.2.2]octane), non-nucleophilic bases (e.g. 1,8-diazabicyclo[5.4.0]undec-7-ene), and/or Lewis acids may be added in the splitting solution to accelerate the splitting of the polyurethane-based fibers, allowing shorter reaction times and/or lower reaction temperatures. Moreover, the addition of a catalyst can have the additional benefit of decomposing dyes, pigments, and/or other additives.

In one embodiment, the splitting solution comprises a catalyst selected from the group consisting of alkali hydroxides, tertiary amines, non-nucleophilic bases, Lewis acids, and mixtures thereof.

In one embodiment, the splitting solution further comprises an oxidant or a reductant. In one embodiment, the splitting solution further comprises an oxidant or reductant to decompose dyes, pigments, and/or other additives.

In one embodiment, the oxidant is selected from the group consisting of hypochlorites, chlorites, peroxides, percarbonates, permanganates, persulfates, dioxygen, ozone, and mixtures thereof. In one embodiment, the oxidant is selected from the group consisting of sodium hypochlorite, sodium chlorite, sodium peroxide, hydrogen peroxide, tert-butylhydroperoxide, di-tert-butyl peroxide, sodium percarbonate, potassium permanganate, sodium persulfate, potassium persulfate, dioxygen, ozone, and combinations thereof.

In one embodiment, the reductant is selected from the group consisting of hydrosulfites, bisulfites, metabisulfites, sulfites, thiosulfates, and mixtures thereof. In one embodiment, the reductant is selected from the group consisting of sodium hydrosulfite, sodium bisulfite, sodium metabisulfite, sodium sulfite, sodium thiosulfate, and combinations thereof.

In one embodiment, the splitting solution comprises a solvent selected from the group consisting of tetrahydrofuran, acetonitrile, acetone, and mixtures thereof.

In one embodiment, the splitting solution comprises a solvent. In one embodiment, the solvent is water and/or an organic solvent. In one embodiment, the organic solvent is selected from the group consisting of ether, ester, ketone, alcohol, aromatic, chlorinated solvents, and combinations thereof. In one embodiment, the organic solvent is selected from the group consisting of methanol, ethanol, tetrahydrofuran, acetonitrile, acetone, and combinations thereof. The amount of solvent in the splitting solution is not particularly limited. However, from a technical and economic standpoint, proportions in the range from 1:3 to 20:1, based on the weight ratio of solvent to textile product, respectively, are preferred.

The method of the invention comprises a step of heating the splitting solution comprising the immersed textile product to split the polyurethane fibers.

In one embodiment, the heating step is performed at a temperature ranging from 40° C. to 250° C., preferably ranging from 50° C. to 200° C., more preferably ranging from 70° C. to 150° C., more preferably ranging from 80° C. to 130° C. In one embodiment, the heating step is performed at a constant temperature. Higher reaction temperatures can be used to decrease the reaction time.

In one embodiment, the duration of the heating step is at least 1 minute, preferably at least 5 minutes, more preferably at least 15 minutes.

In one embodiment, the duration of the heating step is at least 5 min, preferably at least 10 min, 20 min, 30 min, 40 min, 50 min or at least 60 min, more preferably at least 70 min, 80 min, 90 min, 100 min, 110 min, 120 min, 130 min, 140 min, 150 min, 160 min, 170 min or at least 180 min.

In one embodiment, the duration of the heating step ranges from 1 min to 1500 min, preferably ranges from 5 min to 720 min or from 10 min to 360 min, more preferably from 60 min to 360 min.

In one embodiment the heating step is performed in a reducing atmosphere. Inert gasses, like nitrogen, or noble gasses, like argon, can be used to create such reducing atmosphere.

In one embodiment, the heating step is performed in a reactor. Said reactor may be an agitated reactor and/or be sealed gas-tight. Gas-tight sealing is advantageous in particular in embodiments wherein the heating step is performed in a reducing atmosphere.

In one embodiment, the method of the invention comprises, after the heating step (and before the separation step), a step of adding methanol to the solution obtained at the end of the heating step. Such step allows to further dissolve the products resulting from the splitting of the polyurethane fibers.

In one embodiment, the method of the invention further comprise, after the heating step (or after the step of adding methanol to the solution obtained at the end of the heating step if applicable) a step of separating the textile product from the splitting solution (or from the splitting solution complemented with methanol if applicable). Conventional separation techniques that can be used include, without being limited to, filtration, centrifugation, precipitation, distillation, extraction, and combinations thereof.

In one embodiment, the method of the invention further comprises, after the separation step, a step of washing the textile product. In one embodiment, the step of washing the textile product is performed with a washing solution comprising a solvent having a boiling point at standard atmospheric pressure lower than 150° C. In one embodiment, the step of washing the textile product is performed with a washing solution comprising alcohol and/or water, preferably with a washing solution comprising methanol and/or water.

In one embodiment, the method of the invention comprises a drying step after the separation step or after the washing step.

In one embodiment, the method of the invention comprises a step to decolorize the textile product obtained after the separation step, after the washing step, or after the drying step. In one embodiment, the textile product is contacted in the decolorization step with a solution comprising a solvent, an oxidant or an reductant, and, optionally, a base.

The textile product obtained after the method of the present invention may be directly used as raw material in the production of new textile products or be further recycled via the common (thermo-) mechanical and/or chemical recycling methods into recycled textile fibers, yarns, and the like, as well as valuable polymers and/or monomers.

The secondary amines and the optional non-amide solvent may be separated from the splitting solution after the method of the present invention and may be reused in a new splitting solution. Conventional separation techniques that can be used include, without being limited to, filtration, centrifugation, precipitation, distillation, extraction, and combinations thereof.

In one embodiment, the extracted polyurethane fibers and/or polyurethane decomposition products are separated from the splitting solution after the method of the present invention and may be directly used as raw material in the production of new polyurethane-based fibers, yarns, and the like, or further recycled via the common mechanical and/or chemical recycling methods known to the skilled in the art into valuable chemical compounds, which may include polyol compounds, short diol compounds, polyamine compounds, polyurea compounds, and polyisocyanate compounds. Conventional separation techniques that can be used include, without being limited to, filtration, centrifugation, precipitation, distillation, extraction, and combinations thereof.

### EXAMPLES

The present invention is further illustrated by the following examples.

### Materials and Methods

### Chemicals

TABLE 1
chemicals used in the examples

| chemical | CAS# | Source | Purity |
|---|---|---|---|
| Mesitylene | 108-67-8 | Alfa Aesar | 98+% |
| Methanol | 67-56-1 | Fisher Chemical | >=99.9% |
| Dimethyl | 2206-27-1 | Sigma-Aldrich | 99.9% D |
| sulfoxide-d₆ | | | |
| (DMSO-d₆) | | | |
| Dipropylamine | 142-84-7 | Alfa Aesar | 98% |
| Dibutylamine | 111-92-2 | Sigma-Aldrich | 99.5+% |
| Piperidine | 110-89-4 | Thermo Fisher | 99% |
| | | Scientific | |
| Dimethylamine | 124-40-3 | Balchem | >=99.5% |
| Morpholine | 110-91-8 | Sigma-Aldrich | >=99.0% |
| Diethylamine | 109-89-7 | Thermo Fisher | 99+% |
| | | Scientific | |
| Potassium | 865-47-4 | Acros Organics | 98+% |
| tert-butoxide | | | |
| Tetrahydrofuran | 109-99-9 | Sigma-Aldrich | >=99.9%, |
| | | | inhibitor- |
| | | | free |
| Acetonitrile | 75-05-8 | Thermo Fisher | 99.9% |
| | | Scientific | |
| Diisopropylamine | 108-18-9 | Sigma-Aldrich | >=99.0% |
| 2,6- | 504-03-0 | Thermo Fisher | 99% |
| Dimethylpiperidine | | Scientific | |
| Diethylenetriamine | 111-40-0 | Sigma-Aldrich | 99% |
| Ethanolamine | 141-43-5 | Acros Organics | 99% |
| n-Butylamine | 109-73-9 | Thermo Fisher | 99% |
| | | Scientific | |
| Dimethylformamide | 68-12-2 | Acros Organics | 99.8% |
| (DMF) | | | |
| Diethylene glycol | 111-46-6 | Sigma-Aldrich | 99% |
| (DEG) | | | |
| n-Pentylamine | 110-58-7 | Sigma-Aldrich | 99% |

All tested textile products were purchased from De Stoffenkraam, Stationsweg 27, 3362 HA Sliedrecht (Netherlands).

### Methods

500 mg of a fabric comprising polyurethane fibers was shredded into small flakes and placed into a pressure-resistant 10 mL reactor that also included a stirring bar. After adding the splitting solution and 100 μL of mesitylene (internal standard for ¹H NMR spectroscopy), the reactor was closed and sealed gas-tight. The reactor was heated by placing the reactor in a preheated aluminum heating block on a stirring plate, and the mixture was stirred inside the reactor. The temperature was kept constant during the entire reaction.

After the reaction time, the reactor was cooled in an ice bath and opened. The content of the reactor was carefully transferred in a 10 ml glass vial, and 4 mL methanol was added to fully dissolve all decomposition products for analysis purpose. Under stirring, an aliquot of 100 μL of the solution was taken and dissolved in 400 μL DMSO-d₆ and analyzed via ¹H NMR spectroscopy on a BRUKER AVANCE II+600 MHz instrument to determine the conversion of the polyurethane fibers and of the non-polyurethane fibers.

The remaining solution containing the textile was centrifuged at 3000 rpm in a Thermo Fisher Scientific CL10 centrifuge, and the liquid fraction was removed. Next, the remaining textile was washed, which involved adding 8 ml methanol followed by centrifugation at 3000 rpm and removal of the liquid fraction. This washing procedure was repeated two times more. Finally, the remaining textile was dried in a Memmert vacuum oven at 80° C. and 30 mbar for 16 hours.

For the polyurethane fibers, the PU fiber conversion is calculated by dividing the molar amount of detected methylene diphenyl diisocyanate (MDI)-based decompositions products by the molar amount of MDI-based decomposition products that maximally can be formed from the textile product that was added to the reactor. The molar amount of MDI-based decomposition products that maximally can be formed from the textile product that was added to the reactor was calculated based on the weight of the added textile product, the weight fraction of polyurethane fibers in the added textile product, and the composition of the polyurethane fibers. The results are expressed in mol %.

For the polyester fibers, the non-PU fiber conversion is calculated by dividing the molar amount of detected terephthalic acid-based decompositions products by the molar amount of terephthalic acid-based decomposition products that maximally can be formed from the textile product that was added in the reactor. The molar amount of terephthalic acid-based decomposition products that maximally can be formed from the textile product that was added to the reactor was calculated based on the weight of the added textile product, the weight fraction of polyester fibers in the added textile product, and the composition of the polyester fibers. The results are expressed in mol %.

For the cotton- and polyamide fibers, no decomposition products originating from cotton or polyamide, respectively, could be observed via ¹H NMR spectroscopy under the reaction conditions used.

### Results and Conclusions

The results for the different splitting reaction conditions tested are presented in Table 2.

TABLE 2
Conversion of polyurethane (PU) fibers and non-polyurethane (non-PU) fibers.
Temp.: temperature; PET: polyester; PA: polyamide n.d .: not detected

| | | | splitting | Splitting | Conversion (mol %) | |
|---|---|---|---|---|---|---|
| | | | reaction | reaction | Non-PU | PU |
| example | textile | splitting solution | temp. | time | fibers | fibers |
| 1 | 0.5 g fabric | 4 g dipropylamine | 130° C. | 3 h | n.d. | 24 |
| | (12 wt % PU, | | | | | |
| | 88 wt % PET) | | | | | |
| 2 | 0.5 g fabric | 4 g dibutylamine | 130° C. | 3 h | n.d. | 24 |
| | (12 wt % PU, | | | | | |
| | 88 wt % PET) | | | | | |
| 3 | 0.5 g fabric | 4 g dibutylamine | 150° C. | 3 h | n.d. | 68 |
| | (12 wt % PU, | | | | | |
| | 88 wt % PET) | | | | | |
| 4 | 0.5 g fabric | 4 g piperidine | 130° C. | 3 h | 5 | 92 |
| | (12 wt % PU, | | | | | |
| | 88 wt % PET) | | | | | |
| 5 | 0.5 g fabric | 4 g dimethylamine | 110° C. | 3 h | 16 | 93 |
| | (12 wt % PU, | | | | | |
| | 88 wt % PET) | | | | | |
| 6 | 0.5 g fabric | 4 g morpholine | 130° C. | 3 h | 2 | 100 |
| | (12 wt % PU, | | | | | |
| | 88 wt % PET) | | | | | |
| 7 | 0.5 g fabric | 4 g diethylamine | 130° C. | 3 h | n.d. | 99 |
| | (12 wt % PU, | | | | | |
| | 88 wt % PET) | | | | | |
| 8 | 0.5 g fabric | 4 g dibutylamine | 150° C. | 3 h | n.d. | 75 |
| | (12 wt % PU, | 25 mg potassium | | | | |
| | 88 wt % PET) | tert-butoxide | | | | |
| 9 | 1.0 g fabric | 4 g diethylamine | 150° C. | 3 h | n.d. | 94 |
| | (12 wt % PU, | | | | | |
| | 88 wt % PET) | | | | | |
| 10 | 1.0 g fabric | 4 g morpholine | 130° C. | 3 h | 2 | 98 |
| | (12 wt % PU, | | | | | |
| | 88 wt % PET) | | | | | |
| 11 | 1.0 g fabric | 2 g diethylamine | 130° C. | 3 h | n.d. | 99 |
| | (12 wt % PU, | 2 g tetrahydrofuran | | | | |
| | 88 wt % PET) | | | | | |
| 12 | 1.0 g fabric | 2 g diethylamine | 130° C. | 3 h | n.d. | 100 |
| | (12 wt % PU, | 2 g acetonitrile | | | | |
| | 88 wt % PET) | | | | | |
| 13 | 0.5 g fabric | 4 g diethylamine | 130° C. | 3 h | n.d | 93 |
| | (6 wt % PU, | | | | | |
| | 94 wt % PET) | | | | | |
| 14 | 0.5 g fabric | 4 g morpholine | 130° C. | 3 h | n.d | 100 |
| | (8 wt % PU, | | | | | |
| | 92 wt % | | | | | |
| | cotton) | | | | | |
| 15 | 0.5 g fabric | 4 g diethylamine | 150° C. | 3 h | n.d. | 94 |
| | (15 wt % PU, | | | | | |
| | 85 wt % PA) | | | | | |
| 16 | 0.5 g fabric | 4 g diethylamine | 130° C. | 3 h | n.d. | 96 |
| | (12 wt % PU, | 50 mg di-tert-butyl | | | | |
| | 88 wt % PET) | peroxide | | | | |
| 17 | 1.0 g fabric | 3 g morpholine | 130° C. | 10 min | n.d. | 88 |
| | (12 wt % PU, | | | | | |
| | 88 wt % PET) | | | | | |
| 18 | 1.0 g fabric | 0.250 g morpholine | 150° C. | 1 h | n.d. | 90 |
| | (12 wt % PU, | 2.5 g acetonitrile | | | | |
| | 88 wt % PET) | | | | | |
| 19 | 0.5 g denim | 2 g diethylamine | 150° C. | 1 h | n.d. | 98 |
| | jeans (1.5 | 2 g acetonitrile | | | | |
| | wt % PU, | | | | | |
| | 98.5 wt % | | | | | |
| | cotton) | | | | | |
| C1 | 0.5 g fabric | 4 g diisopropylamine | 130° C. | 3 h | n.d. | 17 |
| | (12 wt % PU, | | | | | |
| | 88 wt % PET) | | | | | |
| C2 | 0.5 g fabric | 4 g diisopropylamine | 150° C. | 3 h | n.d. | 18 |
| | (12 wt % PU, | | | | | |
| | 88 wt % PET) | | | | | |
| C3 | 0.5 g fabric | 4 g 2,6- | 130° C. | 3 h | n.d. | 0 |
| | (12 wt % PU, | dimethylpiperidine | | | | |
| | 88 wt % PET) | | | | | |
| C4 | 0.5 g fabric | 4 g | 130° C. | 3 h | 98 | 100 |
| | (12 wt % PU, | diethylenetriamine | | | | |
| | 88 wt % PET) | | | | | |
| C5 | 0.5 g fabric | 4 g ethanolamine | 130 ° C. | 3 h | 94 | 99 |
| | (12 wt % PU, | | | | | |
| | 88 wt % PET) | | | | | |
| C6 | 0.5 g fabric | 4 g n-butylamine | 130° C. | 3 h | 27 | 61 |
| | (12 wt % PU, | | | | | |
| | 88 wt % PET) | | | | | |
| C7 | 0.5 g fabric | 7.5 mL | 80° C. | 4 h | n.d. | 11 |
| | (12 wt % PU, | diisopropylamine | | | | |
| | 88 wt % PET) | | | | | |
| C8 | 0.5 g fabric | 6.75 mL | 80° C. | 4 h | n.d. | 100 |
| | (12 wt % PU, | dimethylformamide + | | | | |
| | 88 wt % PET) | 0.75 mL | | | | |
| | | diisopropylamine | | | | |
| C9 | 0.5 g fabric | 6.75 mL | 80° C. | 4 h | n.d. | 0 |
| | (12 wt % PU, | tetrahydrofuran | | | | |
| | 88 wt % PET) | 0.75 mL | | | | |
| | | diisopropylamine | | | | |

The polyurethane fibers can be efficiently and selectively converted using a splitting solution comprising small secondary amines with low steric hindrance around the nitrogen atom, (examples 1-7). In general, the use of secondary amines with lower steric hindrance around the nitrogen atom results in higher conversions of the polyurethane fibers, but may also result in limited conversion of the non-polyurethane fiber. The addition of a catalyst to the splitting solution, such as potassium tert-butoxide, can result in a slight increase of the conversion of the polyurethane fibers (example 8). Moreover, the fabric product obtained after the described method was noticeably less colored when potassium tert-butoxide was added to the splitting solution. The polyurethane fibers are still efficiently and selectively converted when the weight of the secondary amine in the splitting solution is decreased to 3333% of the weight of polyurethane fibers in the textile product (examples 9-10). By adding (non-amide) solvents, such as tetrahydrofuran and acetonitrile, high conversions of the polyurethane fibers can still be achieved when the weight of the secondary amine in the splitting solution is further decreased to 1667% of the weight of polyurethane fibers in the textile product (examples 11-12). The method of the present invention can be successfully applied to textile materials comprising various amounts of polyurethane fibers and different types of non-polyurethane fibers, such as polyester, polyamide, and cellulose (cotton) fibers (examples 13-15). When an oxidant, such as di-tert-butyl peroxide, was added to the splitting solution, the fabric product obtained after the described method was noticeably less colored (example 16). Following the method of the invention, the polyurethane fibers may already be efficiently and selectively converted in short reaction times (example 17) and the mass of secondary amine in the splitting solution relative to the mass of polyurethane fibers in the textile product may be minimized (example 18). Besides textile products with interwoven polyurethane fibers, the polyurethane fibers could also selectively be removed from textile products, such as denim jeans, based on core-spun yarn in which the core polyurethane fibers are completely wrapped by non-polyurethane fibers, such as cotton (example 19).

Significantly lower conversions are obtained when secondary amines with more steric hindrance around the nitrogen atom are used as splitting agents (examples C1-C3). Only when such bulkier secondary amines are used in combination with amide-based solvents, such as dimethylformamide, high conversions of the polyurethane fibers can be achieved (examples C7-C9).

Besides the polyurethane fibers, also non-polyurethane fibers, such as polyester fibers, may be substantially converted when splitting agents comprising an primary amine group are used, resulting in the undesired disintegration of the textile product (examples C4-C6).

It should be noted that even partial splitting of the polyurethane fibers may be sufficient to substantially or fully remove the polyurethane fibers from the fabric.

1. A method to remove polyurethane fibers from a textile product comprising polyurethane (PU) fibers and non-polyurethane fibers, comprising the steps of:
a. immersing said textile product in a splitting solution comprising a secondary amine, wherein said secondary amine does not contain any primary amine group and wherein each of the two carbon atoms attached to the nitrogen atom in the secondary amine group comprised within said secondary amine form bonds with at least two hydrogen atoms; and,
b. heating said splitting solution comprising said textile product to split the polyurethane fibers, thereby removing polyurethane fibers from said textile product.

2. The method according to claim 1 wherein said secondary amine is of formula (I) 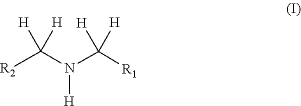
wherein each of R₁ and R₂, is independently selected from H or from the group consisting of alkyl, alkenyl, alkoxy, alkyloxyalkyl, alkyloxyalkyloxy, cycloalkyl, cycloalkoxy, aryl, aryloxy and arylalkyl or wherein R₁ and R₂ form an heterocycle.

3. The method according to claim 1 or 2, wherein said secondary amine is selected from the group consisting of diethylamine, piperidine, morpholine, dimethylamine, pyrrolidine, diallylamine, dipropylamine, dibutylamine, and mixtures thereof.

4. The method according to any one of claims 1 to 3, wherein said secondary amine is selected from the group consisting of diethylamine, piperidine, morpholine, dimethylamine, pyrrolidine, diallylamine, and mixtures thereof, more preferably selected from the group consisting of diethylamine, piperidine, morpholine, dimethylamine, and mixtures thereof.

5. The method according to any one of claims 1 to 4, wherein said secondary amine is selected from the group consisting of diethylamine, piperidine, morpholine, and mixtures thereof.

6. The method according to any one of claims 1 to 5, wherein said secondary amine is diethylamine.

7. The method according to any one of claims 1 to 6, wherein the weight of secondary amine in the splitting solution is at least 80% of the weight of polyurethane fibers in said textile product, preferably at least 200%, 500% or 1000% of the weight of polyurethane fibers in said textile product, more preferably at least 1500% of the weight of polyurethane fibers in said textile product.

8. The method according to any one of claims 1 to 7, wherein the splitting solution further comprises a catalyst selected from the group consisting of alkali hydroxides, tertiary amines, non-nucleophilic bases, Lewis acids and mixtures thereof.

9. The method according to any one of claims 1 to 8, wherein the splitting solution further comprises a solvent, preferably a solvent selected from the group comprising water, an organic solvent, and combinations thereof, more preferably a solvent selected from the group consisting of tetrahydrofuran, acetonitrile, acetone, and mixtures thereof.

10. The method according to any one of claims 1 to 9, wherein step b is performed at a temperature ranging from 40° C. to 250° C., preferably ranging from 50° C. to 200° C., more preferably ranging from 70° C. to 150° C., more preferably ranging from 80° C. to 130° C.

11. The method according to any one of claims 1 to 10 wherein the duration of step b is at least 1 min, 5 min or 15 min, preferably at least 20 min, more preferably at least 60 min, even more preferably at least 120 min.

12. The method according to any one of claims 1 to 11, wherein said non-polyurethane fibers comprise polyester fibers.

13. The method according to any one of claims 1 to 12, further comprising, after the heating step, the step of:
c. separating the textile product from the splitting solution and, optionally, separating said secondary amine and/or solvent from the splitting solution.

14. The method according to claim 13 further comprising, after the separating step, the step of:
d. washing the textile product; and/or
e. decolorizing the textile product.

15. The method according to any one of claims 1 to 14, wherein the splitting solution further comprises an oxidant or a reductant.
